(19) United States
(12) Patent Application Publication
(10) Pub. No.: US 2025/0130069 A1
(43) Pub. Date: Apr. 24, 2025

(54) MOVING IMAGE MAP PROCESSING METHOD, DEVICE, SYSTEM AND VEHICLE THEREOF

(71) Applicant: AutoSys (TW) Co., Ltd., Hsinchu County (TW)

(72) Inventors: Jui-Li Chen, Hsinchu County (TW); Guan-you Lin, Hsinchu County (TW); Chia-Ling Cheng, Hsinchu County (TW); Tse-Min Chen, Hsinchu County (TW)

(21) Appl. No.: 18/884,058

(22) Filed: Sep. 12, 2024

(30) Foreign Application Priority Data
Oct. 23, 2023 (TW) 112140345

(51) Int. Cl. G01C 21/00; H04N 7/18

(52) U.S. Cl. CPC G01C 21/3859; G01C 21/3848; H04N 7/183

(57) ABSTRACT

The disclosure provides an update image map method applied to a vehicle, which comprising the following steps of: receiving a message used to determine whether conditions for updating an image map are met; determining whether the conditions for updating the image map are met according to the message; when it is determined that the conditions for updating the image map are met, receiving a vehicle information and capturing images from one or more cameras; processing the images based on lens characteristics of the one or more cameras and the vehicle information; and writing the processed images to a corresponding location on the image map based on the received vehicle information.

This non-provisional application claims priority claim under 35 U.S.C. § 119 (a) on Taiwan Patent Application No. 112140345 filed Oct. 23, 2023, the entire contents of which are incorporated herein by reference.

### FIELD OF THE INVENTION

The disclosure relates to an image processing, in particular to an image processing for dynamic vehicle.

### BACKGROUND

Vehicles, boats, and other types of vehicles are typically equipped with many windows in the driver's cabin to allow the driver to view the surroundings. However, there are still many visual blind spots, for example, the ground beneath the vehicle, areas obstructed by the vehicle's beams and pillars, etc. To compensate for these visual blind spots to enhance the safety of vehicle operation, multiple cameras or image sensors are generally installed to shoot the surroundings of the vehicle. The images including these visual blind spots are then transmitted to a dashboard inside the driver's cabin and/or to the driver's helmet display.

In order to serve as evidence in accidents or serve as sensors for autonomous driving, current camera lenses can have resolutions up to 2K or 4K standards. The sampling rate of this full-color 24-bit camera can be as high as several dozen frames per second, which is higher than 30 frames per second of human visual persistence. However, processing the continuous images transmitted by multiple cameras requires a substantial amount of computational resources. Since the demand of typical vehicle is not to create a mobile photo studio but to provide situational awareness for the driver at normal driving speeds. Therefore, there is a need for an information system that can provide situational awareness around the vehicle using fewer computational resources in order to reduce costs.

### SUMMARY

In one embodiment, the disclosure provides an update image map method applied to a vehicle, comprising: receiving a message used to determine whether conditions for updating an image map are met; determining whether the conditions for updating the image map are met according to the message; when it is determined that the conditions for updating the image map are met, further comprising: receiving a vehicle information and capturing images from one or more cameras; processing the images based on lens characteristics of the one or more cameras and the vehicle information; and writing the processed images to a corresponding location on the image map based on the received vehicle information.

Preferably, in order to determine the corresponding location of the image map, wherein the vehicle information includes a current position and a current heading angle of the vehicle.

Preferably, in order to obtain the vehicle information is obtained from one or any combination of the following: a vehicle information system; and a navigation and positioning system.

Preferably, in order to smooth the brightness of the images in the image map, wherein the step of processing the images further includes adjusting a brightness of the written images based on one or any combination of the following: according to existing images around the corresponding location on the image map; and according to adjacent received images.

Preferably, in order to satisfy the driver's situation awareness, wherein the conditions for updating the image map includes one or any combination of the following: a relative displacement of the vehicle exceeds a threshold; a relative heading angle of the vehicle exceeds another threshold; a current speed of the vehicle exceeds a speed threshold; a steering angle of a steering mechanism of the vehicle exceeds a steering angle threshold; and a time elapsed since the previous step of writing the processed images exceeds a time threshold.

Preferably, in order to provide the conditions for determining the next update image map, the update image map method further comprising: setting the conditions for updating the image map.

Preferably, in order to have enough time to organize the image map, wherein when it is determined that the conditions for updating the image map are not met, executing one or a combination of the following steps: organizing the image map; and pausing for a period of time.

Preferably, in order to display a portion of the image map that corresponds to the current location of the vehicle, the disclosure further provides a display image map method, comprising: executing the update image map method as previously described; reading a corresponding part of the image map based on the vehicle information; and transmitting the corresponding part of the read image map to a display module and displaying the corresponding part of the read image map on the display module.

Preferably, in order to initialize the image before updating the image map, the disclosure further provides an initialization image map method, comprising the following steps before executing the update image map method as previously described: creating a blank image map; executing the step of receiving the vehicle information; executing the step of processing the images; executing the step of writing the processed images to the corresponding location on the image map; and executing the update image map method.

In one embodiment, the disclosure further provides a moving image map processing device, comprising: at least one processor, used to execute a plurality of instructions to implement the update image map method as previously described; and a memory, used to store the image map.

In one embodiment, the disclosure further provides a moving image map processing device, comprising: at least one processor, used to execute a plurality of instructions to implement the display image map method as previously described; a memory, used to store the image map; and an input and output interface, used to transmit the corresponding part of the read image map to the display module.

In one embodiment, the disclosure further provides a moving image map processing system, comprising the moving image map processing device and the display module.

In one embodiment, the disclosure further provides a vehicle having moving image map processing capability, comprising: the moving image map processing system and the one or more cameras.

In one embodiment, the disclosure further provides a moving image map processing device, comprising: at least one processor, used to execute a plurality of instructions to implement the initialization image map method as previously described; and a memory, used to store the image map.

According to various embodiments, this disclosure provides an information system that can offer situational awareness of the area surrounding the vehicle while using fewer computational resources, thereby reducing costs and providing drivers with situational awareness at normal driving speeds.

### BRIEF DESCRIPTION OF THE DRAWINGS

FIG. 1 is a block diagram of a moving image map processing device 100 according to one embodiment of the disclosure.

FIG. 2A is a top view of shooting range of multiple cameras 140 configured on a vehicle according to one embodiment of the disclosure.

FIG. 2B is a top view of shooting range of multiple cameras 140 configured on a vehicle according to another embodiment of the disclosure.

FIG. 3 is a schematic diagram of a vehicle motion model according to one embodiment of the disclosure.

FIGS. 4A to 4C are a schematic diagram of vehicle motion model and rotation angle.

FIG. 5 is a schematic diagram of updating the image map at intervals according to one embodiment of the disclosure.

FIG. 6 is a timing diagram of the update of the image map according to one embodiment of the disclosure.

FIG. 7 is a block diagram of a moving image map processing method 700 according to one embodiment of the disclosure.

FIG. 8 is a block diagram of the initialization image map method 710 according to one embodiment of the disclosure.

FIG. 9 is a block diagram of the update image map method 720 according to one embodiment of the disclosure.

FIG. 10 is a block diagram of the display image map method 730 according to one embodiment of the disclosure.

### DETAILED DESCRIPTION OF THE PREFERRED EMBODIMENTS

To clarify the objectives, technical solutions, and advantages of this present disclosure, a detailed description of the proposed technical solution will be provided below. Apparently, the described implementations are merely some rather than all of the implementations of the disclosure. All other implementations obtained by a person of ordinary skill in the art based on the implementations of the present specification without creative efforts shall fall within the protection scope of the present disclosure.

The terms “first”, “second”, “third”, and the like in the description, claims, and drawings are used to distinguish between different objects, rather than used to indicate a specified order or sequence. It should be understood that the objects described in this way may be exchanged when appropriate. In the description of the present disclosure, “plurality” means two or more, unless otherwise expressly and specifically qualified. Furthermore, the terms “include” and “comprise” as well as any variants thereof are intended to cover non-exclusive inclusion. Some of the block diagrams shown in the drawings represent functional entities and may not necessarily correspond to physically or logically separate entities. These functional entities may be implemented in software form, or implemented in one or more hardware circuits or integrated circuits, or implemented in different networks and/or processor devices and/or microcontroller devices.

In the descriptions of the present disclosure, unless otherwise specified and limited, it should be noted that terms “mounting”, “mutual connection” and “connection” should be generally understood. For example, the term may be fixed connection, detachable connection or integrated connection may be mechanical connection or electrical connection, may be direct connection, may be indirect connection through an intermediate, or may be internal communication between two elements. A person of ordinary skill in the art may understand specific meanings of the above terms in the present disclosure according to specific situations.

In order to make the objectives, technical solutions, and advantages of the present application more apparent and easy to understand, the present application will be further detailed below in conjunction with the drawings and specific embodiments.

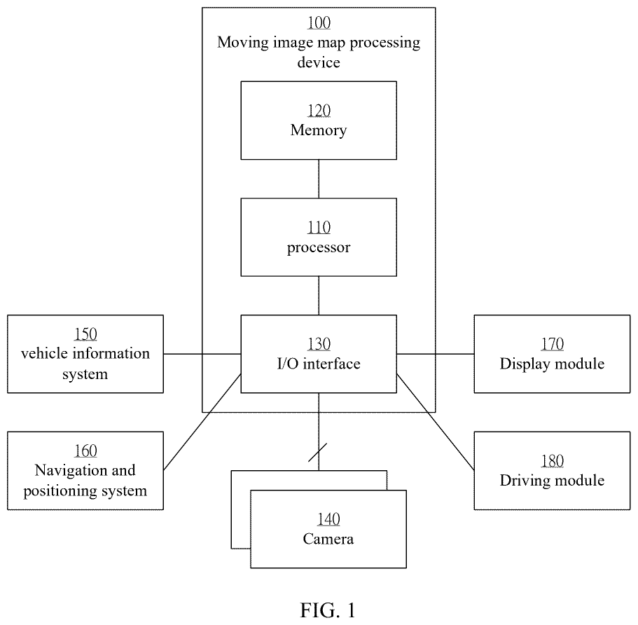

Referring to FIG. 1, there are shown a block diagram of a moving image map processing device 100 according to one embodiment of the disclosure. In some embodiments, the moving image map processing device 100 can is an embedded device. For example, it may be implemented on a daughter board that includes one or more external I/O interfaces 130 (such as PCI-Express, SCSI, SATA, USB, etc.) connected to a bus of a host. The daughter board can be inserted into an expansion slot of the host, and communicates with the host and other devices installed on the host via the I/O interfaces 130.

In other embodiment, the moving image map processing device 100 can be a standalone device that communicates with other devices via one or more external I/O interfaces 130. For example, if a vehicle has a general information bus, the moving image map processing device 100 can be connected to this information bus via the I/O interfaces 130 to interact with other devices on the information bus. For instance, military vehicles are having buses such as MIL-STD 1553B and MIL-STD-1776A.

The moving image map processing device 100 may include one or more processors 110. The processor 110 can be microprocessor, microcontroller, graphics processing unit (GPU), digital signal processor (DSP), and/or application-specific integrated circuit (ASIC).

The processor 110 can execute an operating system stored in a non-volatile memory to control the moving image map processing device 100. In addition to being an ordinary operating system, the operating system can also be an operating system suitable for embedded system, or a real-time operating system. The processor 110 can execute one or more application programs to implement the embodiments provided in this disclosure. The application program includes a plurality of instructions that can be executed by the processor 110.

Memory 120 can include the non-volatile memory (such as flash or EEPROM) used for storing the aforementioned application program and the operating system, or include the volatile memory (such as various DDR SDRAM) used as system memory, or include high-speed image memory used for image processing. For example, the high-speed image memory has two I/O ports that can store and read data at the same data to speed up image processing operations.

The moving image map processing device 100 is connected to one or more camera 140 via the I/O interface 130. The cameras 140 and the moving image map processing device 100 can be installed on the same vehicle. In one embodiment, there can be four cameras 140 installed on the vehicle, positioned at the front, rear, left, and right, corresponding to these four directions. In other embodiment, there can be two wide-angle cameras (e.g., the shooting angle of the two wide-angle cameras exceeds 180 degrees, respectively) installed back-to-back in two opposing directions on the vehicle. In another embodiment, there can be three wide-angle cameras (e.g., the shooting angle of the three wide-angle cameras exceeds 120 degrees, respectively), with their shooting centers spaced 120 degrees apart, installed in three corresponding directions on the vehicle.

In one embodiment, the cameras 140 may have the same lens characteristics. In other embodiment, because the vehicle has a higher probability of moving forward or backward, in order to enhance the resolution of the images captured at the front or rear, the field of view of the cameras shooting forward and/or backward can be narrower to reduce image distortion. In other words, the cameras shooting left and/or right may have wider fields of view, with greater image distortion.

The processor 110 can drive the cameras 140 to capture images via the I/O interface 130. In one embodiment, the outputs of the cameras 140 are shared with other systems, such as autonomous vision driving system or incident recording system. The autonomous vision driving system and the incident recording system require high frame rates and high-quality images. Since the moving image map processing device 100 does not need continuous or uninterrupted images, the moving image map processing device 100 can intermittently or periodically capture a single frame from the multiple frames in continuous output. For example, when the frame rate of the camera 140 is 60 frames per second, the moving image map processing device 100 can periodically capture one frame for every two frames, so that the frame rate is 30 frames per second. Alternatively, images can only be captured by the camera 140 after receiving a specific instruction.

The processor 110 can obtain the information related to the vehicle from a vehicle information system 150 in the same vehicle. The information related to the vehicle, combined with movement and steering characteristics indicated by a vehicle's physical model, can be used to infer and estimate the vehicle's position. In one embodiment, the vehicle information system 150 can output the information related to the vehicle according to a controller area network (CAN bus) that is a vehicle bus standard, and broadcast the vehicle's control status on the CAN bus. The vehicle information system 150, combined with the specific physical model information of the vehicle, can calculate the vehicle's relative position and heading after a certain period of movement.

In addition to obtaining the information related to the vehicle from the vehicle information system 150, the vehicle's relative position and heading after a certain period of movement can be estimated from a navigation and positioning system 160. The navigation and positioning system 160 can be one or more terminals of a Global Navigation Satellite System (GNSS), such as Global Positioning System (GPS), BeiDou Navigation Satellite System, GLONASS, or Galileo. The navigation and positioning system 160 can be an Inertial Navigation System (INS) that utilizes a gyroscope, accelerometer, angular accelerometer, or any combination of these. The navigation and positioning system 160 can also be a combination of a Global Navigation Satellite System (GNSS) with an Inertial Navigation System (INS). Based on a trajectory outlined by the navigation and positioning system 160, the vehicle's relative position and heading after a certain period of movement can be estimated.

In one embodiment, the memory 120 contains a data structure for an image map. After processing the images captured by the camera 140, the processor 110 writes, replaces, or updates the processed images in the corresponding parts of the data structure of the image map according to the vehicle's position and heading corresponding to the time sequence.

The surrounding portions of the vehicle in the image map can be output to a display module 170. The display module 170 may include a display in the driver's cabin or a driver's helmet display. After viewing the image map of the vehicle's surroundings, the driver can enhance situation awareness so as to drive the vehicle safer.

In one embodiment, all or part of the image map can be outputted to a driving module 180. The driving module 180 can include automatic or assisted driving functions by artificial intelligence. If a dangerous area is detected in the image map, the driving module 180 can automatically avoid it or alert the driver to take evasive action. If areas that need to be approached are detected in the image map, such as charging port, parking space, or fuel pump, the driving module 180 can provide automatic navigation or assist in guiding the driver.

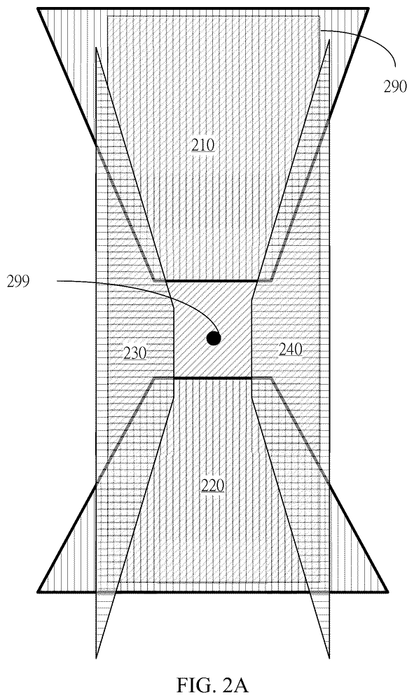

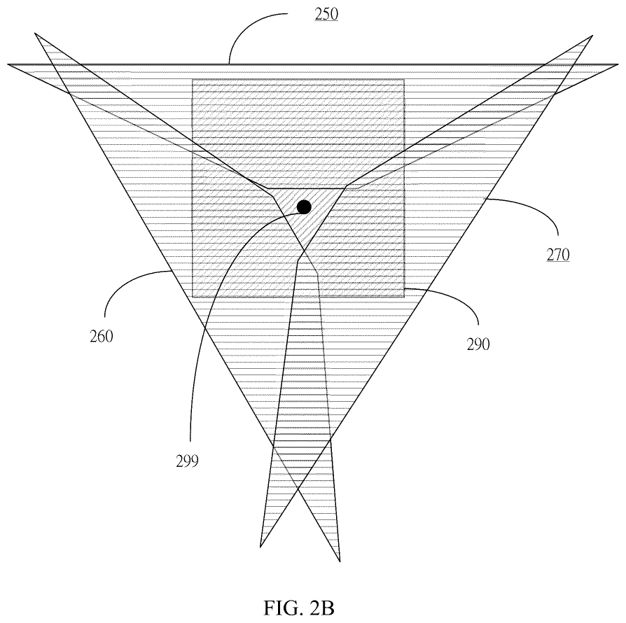

Referring to FIG. 2A, there is shown a top view of shooting range of multiple cameras 140 configured on a vehicle according to one embodiment of the disclosure. In FIG. 2A, the vehicle is configured with four cameras 140, which include a camera 140 with a forward shooting range 210, a camera 140 with a backward shooting range 210, a camera 140 with a left shooting range 210, and a camera 140 with a right shooting range 210. The shooting angles of the shooting ranges 210 and 220 may be different. Similarly, the shooting angles of the shooting ranges 210 and 230 may also be different.

An imaging plane of the camera 140 configured on the vehicle is not parallel to a ground plane (or a sea surface, which will hereafter be referred to as the ground plane), but rather forms an angle with the ground. The moving image map processing device 100 can transform the image formed on the imaging plane into an image of the ground plane by using a linear or non-linear transformation based on the lens characteristics of the camera 140. In one embodiment, the camera 140 can be focused at infinity, but the linear or nonlinear transformation only maps the image to a certain distance on the ground plane. As shown in FIG. 2A, the forward shooting range 210 can be a trapezoid.

Similarly, images of the other three cameras 140 can also be converted into shooting ranges of 220, 230 and 240 respectively according to their lens characteristics. As shown in FIG. 2A, the shooting ranges 220 to 240 can also be trapezoid. Due to the configuration of cameras 140 on the vehicle, there may be blank spaces among the four trapezoids. The relationship between the shooting ranges 210 to 240 and the center position 299 of the vehicle is fixed. Therefore, in one embodiment, the processor 110 can write, replace, or update the shooting ranges 210 to 240 in the corresponding parts of the image map's data structure.

Since the shooting ranges 210 to 240 are trapezoidal, it is inconvenient to write into the data structure and requires more computing resources. Therefore, a rectangular or square area 290 can be defined corresponding to the center position 299 of the vehicle. The processor 110 can write the above-mentioned shooting ranges 210 to 240 only within the area 290 of the image map to save computing resources. The processor 110 can only write the shooting ranges 210 to 240 within the area 290 of the image map to save computational resources. However, those skilled in the art will understand that it is not always necessary to define the area 290.

Although in the top view shown in FIG. 2A, the vehicle's heading is directed towards the top of the image map or at 0 degrees, the vehicle may head in different directions on the image map as the vehicle moves. Those skilled in the art will understand that the shooting ranges 210 to 240 and the area 290 will rotate on the image map as the vehicle moves.

Since there is a partially overlapping area between two adjacent shooting ranges, in one embodiment, the later-written shooting range can overwrite the previously written shooting range based on the timing of writing the shooting ranges 210 to 240. In another embodiment, in order to compensate for the difference in characteristics of the two lenses, such as different aberrations, the overlapping area or the edge of the image can be specially processed during the linear or non-linear transformation, so as to reduce the differences between the overlapping areas and other adjacent areas.

In one embodiment, after a certain shooting range is written, the image map may have brightness differences with the adjacent image map, resulting in the obvious seam lines in the image map. Therefore, the shooting range to be written can be adjusted so that the image map after writing the shooting range does not have obvious inconsistencies or high-frequency parts. For example, image processing can be performed on the edges of the shooting range based on gradient proportion blending or other smoothing image processing techniques.

Referring to FIG. 2B, there is shown a top view of shooting range of multiple cameras 140 configured on a vehicle according to another embodiment of the disclosure. In FIG. 2B, the vehicle is configured with three cameras 140, which include a camera 140 with a forward shooting range 250, a camera 140 with a left-rear shooting range 260, and a camera 140 with a right-rear shooting range 270. The shooting angles of the shooting ranges 250, 260, and 270 may be different or the same.

Those skilled in the art will understand that, except for the number and installation direction of the cameras 140, the embodiment of FIG. 2B can be applied to the various descriptions of the embodiment shown in FIG. 2A. Besides, the disclosure does not limit the number of cameras configured on the vehicle.

One of the advantages of this disclosure is to save the computational resources. Because the vehicle equipped with the moving image map processing device 100 has considerable restrictions, such as volume/size limitations, weight restrictions, power supply constraints, environmental control limitations, and vibration restrictions, these restrictions factors impact the design of the moving image map processing device 100. Therefore, it is necessary to save computational resources as much as possible, particularly concerning the frequency of image processing and writing to the image map.

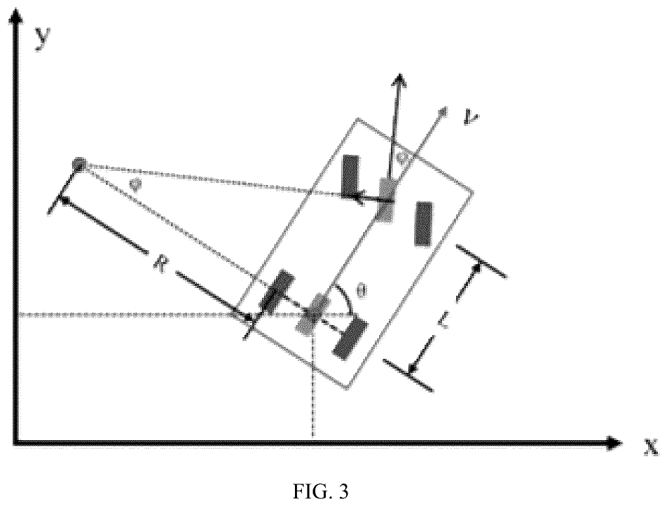

According to an embodiment of this disclosure, after receiving the vehicle information broadcasted by the vehicle information system 150, the processor 110 will calculate new relative positions and heading angles of the vehicle based on a vehicle motion model. Referring to FIG. 3, there is shown a schematic diagram of a vehicle motion model according to one embodiment of the disclosure. The vehicle has a pair of rear wheels that do not steer and a pair of front wheels that steer at the same time. A vehicle center can be set at the midpoint of the rear axle between the rear wheels. By combining a wheelbase between the front and rear axles with the front wheel steering angle, the corresponding relationship between the front axle and the vehicle center (i.e., the midpoint of the rear axle) can be determined. A line connecting the front axle and the vehicle center represents the vehicle's heading angle. X-axis and y-axis can correspond to the two axes of the image map, respectively.

As shown in Table 1, it describes the equations (1) to (4) of the vehicle motion model.

TABLE 1
Vehicle Motion Model

| | |
|---|---|
| ${R}_{f} = \frac{L}{sin ϕ} ,$ | (1) |
| ${R}_{r} = \frac{L}{tan ϕ}$ | |
| x_{f} = xᵣ + L · cosθₜ₊₁ | (2) |
| y_{f} = yᵣ + L . sinθₜ₊₁ | |
| ${x}_{r} ( t ) = L \cdot cot ϕ \cdot sin ( \frac{v \cdot sin ϕ}{L} t )$ | (3) |
| ${y}_{r} ( t ) = - L \cdot cot ϕ \cdot cos ( \frac{v \cdot sin ϕ}{L} t ) + L \cdot cot ϕ$ | |
| ${θ}_{t + 1} = {θ}_{t} + \frac{v \cdot sin ϕ}{L} t$ | (4) |

The vehicle motion model includes wheelbase (L), wheel steering angle (ϕ), front/rear vehicle rotation radius (R_f/R_r), vehicle front wheel axle center coordinates and vehicle rear wheel axle center coordinates ((x_f, y_f), (x_r, y_r)), vehicle heading angle (θ), vehicle speed (v) corresponding to the vehicle heading angle (θ), and time (t). The vehicle coordinates are obtained by introducing the vehicle speed and wheel steering angle, along with the vehicle motion model, to calculate the driving distance and the vehicle's heading angle, and then continuously accumulate the vehicle coordinates, the driving distance, and the vehicle heading angle to calculate the estimated vehicle position information.

If the vehicle's initial angle and coordinate are 90° and (0, 0), respectively. The movement relationship of the vehicle at two different times can be split into a rotation matrix R(θ) and a translation matrix T(x). The rotation matrix R(θ) describes the magnitude of the angular transformation (θ) of the vehicle body, while the translation matrix T(x) represents the movement of the vehicle on the x-y plane. The rotation matrix R(θ) and translation matrix T(x) are combined into an affine transformation matrix.

TABLE 2
Affine Transformation Matrix

| | |
|---|---|
| $R ( θ ) + T ( x ) ⇒ [ \begin{matrix}cos θ & sin θ & {t}_{x} \\ sin θ & cos & {t}_{y} \\ 0 & 0 & 1\end{matrix} ]$ | (5) |

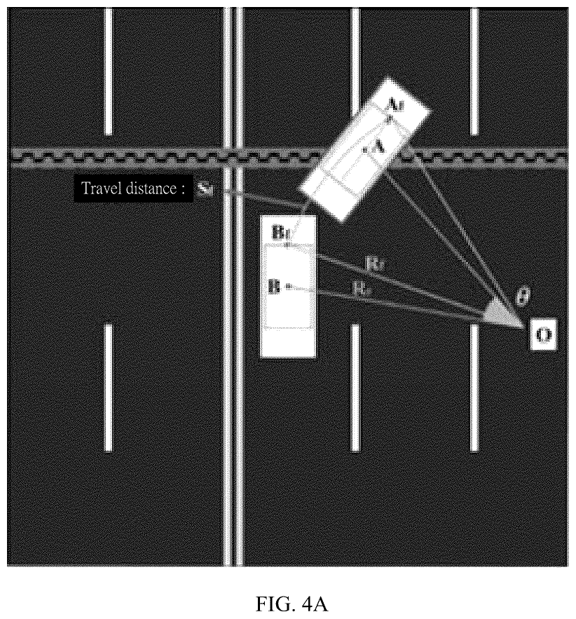

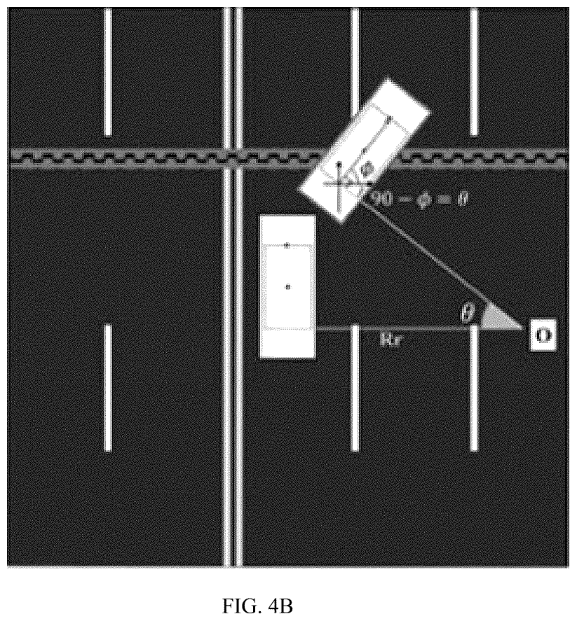

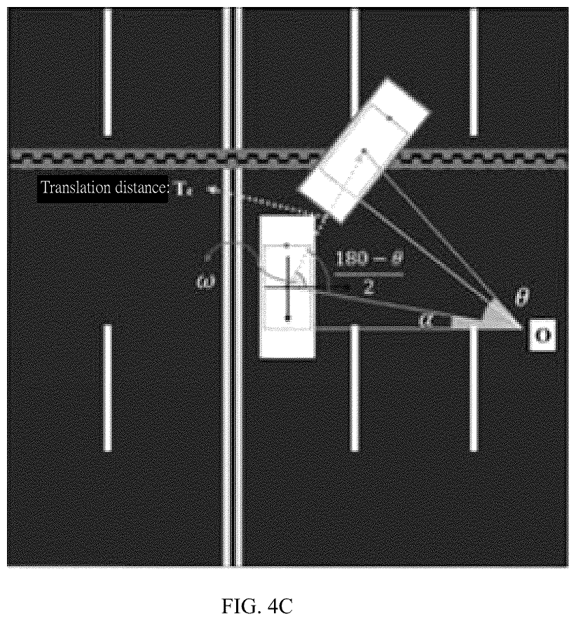

When the broadcast interval of the vehicle information is short, it is assumed that the front wheel angle remains unchanged, that is, the vehicle rotates round a fixed center as the origin at both moments. As shown in FIGS. 4A to 4C, an instantaneous rotation angle can be obtained by dividing the vehicle movement distance between the two moments by the turning radius of the rear axle. Then, The instantaneous rotation angles can be continuously accumulated to obtain the vehicle heading angle (θ).

TABLE 3
Line Segment Detection Loss Function

| | |
|---|---|
| $θ = \frac{{S}_{f}}{{R}_{f}}$ | (6) |
| ${T}_{c} = 2 \times {R}_{c} \times sin ( \frac{θ}{2} )$ | (7) |
| $α = {sin}^{- 1} ( \frac{L}{2} \times \frac{1}{{R}_{c}} )$ | (8) |
| $ω = \frac{180 - θ}{2} - α$ | (9) |
| Tₓ = T_{c} × cos ω T_{y} = T_{c} × sin ω | (10) |

Furthermore, the displacement of the vehicle is obtained from the movement distance of the vehicle center and the vehicle heading angle (θ) at two different moments. As shown in FIG. 4C and Table 3, Tc is the vehicle translation distance, a is the angle between the line from the rear axle to the rotation center and the line from the rear axle to the vehicle center, and w is the translation direction. The component Ty on the x-axis and the component Ty on the y-axis are calculated from the above parameters.

In one embodiment, the estimated vehicle's relative displacement and heading angle can be obtained through the above calculation of the vehicle information. In another embodiment, the estimated vehicle's relative displacement and heading angle can be obtained by the positioning information provided by the navigation and positioning system 160. Therefore, the disclosure can calculate update points on the image map. When the vehicle moves to the update points on the image map or moves into the error range near the update points on the image map, it will perform the above steps of capturing the image, processing the shooting range (such as ground projection, map coordinate transformation, brightness conversion, etc.), and writing, replacing, and updating the shooting range to the corresponding part of the image map.

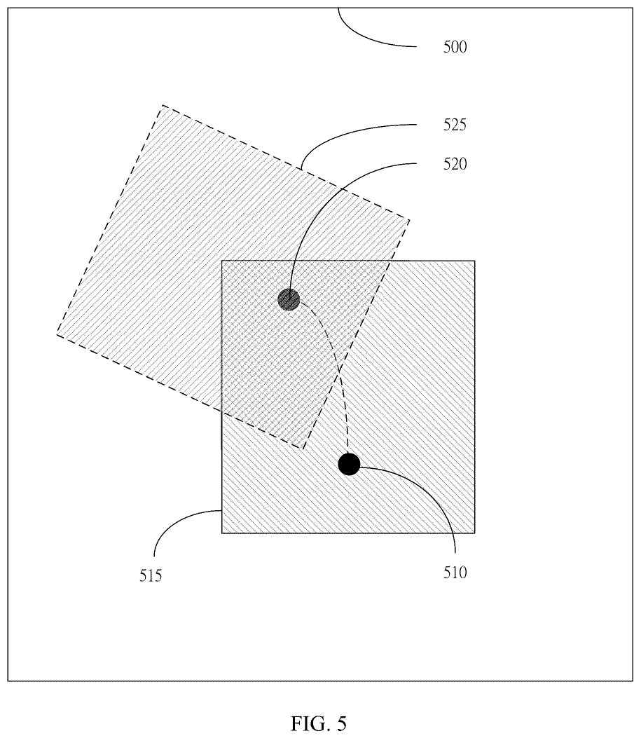

Referring to FIG. 5, there is shown a schematic diagram of updating the image map at intervals according to one embodiment of the disclosure. As shown in FIG. 5, an image map 500 can be stores in the data structure of the memory 120. When the application program is initialized, the image map 500 may be filled with initialized image values, such as all white or all black. A center position 510 of the vehicle (which may be the center point of the rear axle) may also be set as an initialization point (such as the center point of the image map 500) during initialization of the image map 500. After initialization, the initially processed shooting range can be written, replaced, or updated in the corresponding part of the initialized image map.

When the vehicle moves, the processor 110 can estimate the vehicle's relative displacement and heading angle at a specific timing based on the vehicle information and/or the historical positioning information. The specific timing can be fixed or may change depending on the vehicle's speed. For example, when the shooting range is 30 meters away and the vehicle's speed is 2 meters per second, the timing for updating the image map can be set after 0.5 seconds. When the vehicle's speed increases to 10 meters per second, the timing for updating the image map can be set to 0.1 seconds later.

For continuously providing situational awareness, in some examples, even when the vehicle is stationary, that is, when the estimated vehicle's position and heading angle are the same as the current vehicle's position and heading angle, the timing for updating the image map will be set to a minimum value. For example, when the vehicle is stationary, the timing for updating the image map can be set to 0.8 seconds or 1 second.

In one embodiment, the processor 110 can calculate the vehicle's relative displacement and heading angle at the time of updating the image map, perform the aforementioned steps of capturing the image, process the shooting range (such as ground projection, map coordinate transformation, brightness adjustment, etc.), and write, replace, and update the shooting range into the corresponding part of the image map. Then, the next update time for the image map is calculated.

Taking the embodiment shown in FIG. 5 as an example, when the center of the vehicle is located at a first position 510, the shooting range 515 in the image map 500 can be updated. Then, the next update time for the image map is calculated. After the next update time has passed, the center of the vehicle has moved from the first position 510 to a second position 520, and the corresponding shooting range 525 also changes according to the vehicle's center displacement and heading angle. Similarly, the processor 110 can perform the aforementioned steps of capturing the image, process the shooting range (such as ground projection, map coordinate transformation, brightness adjustment, etc.), and write, replace, and update the shooting range in the corresponding part of the image map. Then, the next update time for the image map is calculated, and this process continues in a cycle.

In another embodiment, the processor 110 can continuously receive the aforementioned vehicle information and/or positioning information to calculate the current vehicle's relative displacement and heading angle. When certain conditions are met, such as when the rotation angle of the relative displacement and/or heading angle exceeds a threshold, the processor 110 can perform the aforementioned steps of capturing the image, process the shooting range (such as ground projection, map coordinate transformation, brightness adjustment, etc.), and write, replace, and update the shooting range in the corresponding part of the image map. Then, the processor 110 can continue to receive the aforementioned vehicle information and/or positioning information, calculate the current vehicle's relative displacement and heading angle, and determine whether the aforementioned conditions are met, repeating this process cyclically.

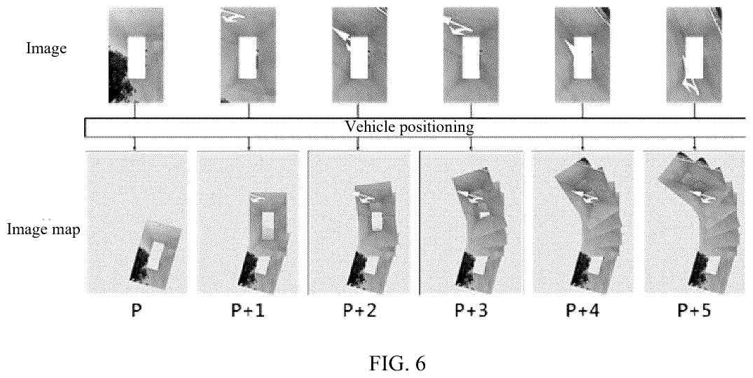

Referring to FIG. 6, there is shown a timing diagram of the update of the image map according to one embodiment of the disclosure. FIG. 6 is divided into an upper section and a lower section. The upper section shows the shooting ranges for multiple image map update steps. For clarity, these shooting ranges can belong to the aforementioned area 290. The lower section contains the image map. The timing of the middle in FIG. 6 indicates six image update steps progressing from left to right. In the embodiment of FIG. 6, the vehicle is continuously making a left turn.

As previously mentioned, the processor 110 can update the image map after a certain period of time has passed or when certain conditions are met. During the image update step at the first time, the image area of the first shooting range is updated to the corresponding part of the initialized image map so as to form an image map P. In the image update step at the second time, the image area of the second shooting range is updated to the corresponding part of the image map so as to form an image map P+1. In the image map P+1, since the vehicle turns forward and left, the image area of the second shooting range is updated to the front-left area of the part of the updated image at the first time. Additionally, because the vehicle's heading angle is rotating counterclockwise, the image area of the second shooting range also rotates counterclockwise.

Thus, this process continues cyclically, during the image update step at the sixth time, the image area of the shooting range at the sixth time is updated to the corresponding part of the image map so as to form image map P+5. As shown in the lower section of FIG. 6, the image map is sequentially updated.

In one embodiment of the disclosure, the processor 110 can periodically read a partial image of the image map according to the display frame rate of the display module 170 and based on the current vehicle's position and heading angle in the image map. In one embodiment, the partial image may include images of the area near the vehicle in the image map.

As previously mentioned, the number or frequency of executing the reading steps of the partial image of the image map is determined based on the requirements of the display module 170, and has nothing to do with whether the image update conditions are met. For example, if the vehicle is stationary for five minutes, the processor 110 will perform 300 image updates during this period according to the minimum update interval (such as 1 second) required for situational awareness. However, when the display module 170 displays at 60 frames per second, 18,000 display steps are executed within these five minutes.

Due to the high likelihood of the vehicle being stationary, the memory module 120 may include a high-speed display image map cache memory. Each time a partial image of the image map is read, the read partial image can be temporarily stored in the high-speed display image map cache memory. If the vehicle is stationary, the contents of the high-speed display image map cache memory can be provided to the display module 170 without the need for the processor 110 to read the image map every time, thereby further saving computational resources.

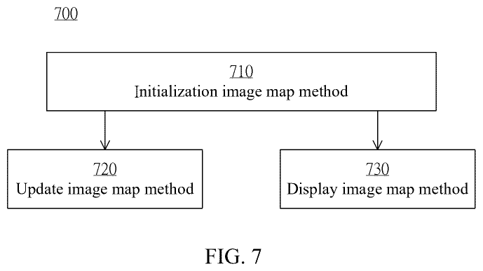

Referring to FIG. 7, there is shown a block diagram of a moving image map processing method 700 according to one embodiment of the disclosure. The moving image map processing method 700 can be executed by the moving image map processing device 100 shown in FIG. 1, and is particularly implemented by an application program composed of a plurality of instructions executed by the processor 110. If there is no direct or indirect causal relationship between any two steps, the disclosure does not restrict the execution order of these two steps. The moving image map processing method 700 can execute an initialization image map method 710 after the vehicle is started. In one embodiment, after the image map is initialized, an update image map method 720 and a display image map method 730 can be executed in parallel. In one embodiment, the processor 110 includes a plurality of execution units specifically for parallel execution of the update image map method 720 and the display image map method 730. In another embodiment, an operating system executed by the processor 110 may support multi-threading or multi-processing to virtually execute the update image map method 720 and the display image map method 730 in parallel. Those skilled in the art with knowledge in information science and information engineering will understand various modifications of the aforementioned embodiments.

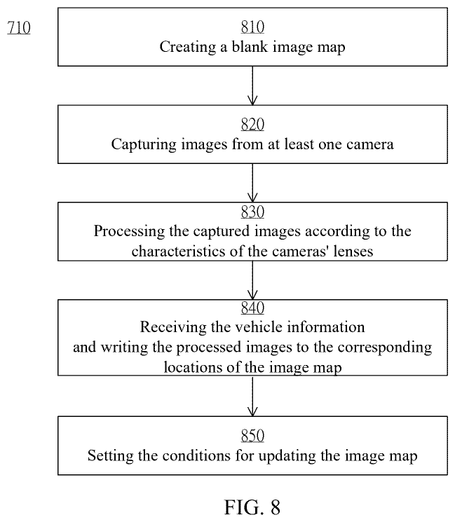

Referring to FIG. 8, there is shown a block diagram of the initialization image map method 710 according to one embodiment of the disclosure. The initialization image map method 710 is started at step 810.

In step 810, creating a blank image map. In one embodiment, a data structure may be constructed in the memory 120, and used to store the blank image map. In another embodiment, the data structure in the memory 120 can be initialized so that the image values of the image map are set to initialization values or blank values. For example, the initialization values are all black values, all white values, or transparent values. In one embodiment, the image map contains two vertical orientation axes, one of which can be aligned to the vehicle's heading angle.

In step 820, capturing images from at least one camera 140. One embodiment, the captured images can be stored in parallel by the using of Direct Memory Access (DMA).

In step 830, processing the captured images according to the characteristics of the cameras' lenses. As mentioned earlier, the images can be transformed into ground images through linear or nonlinear transformation. Additionally, the brightness of the ground images can be adjusted based on the differences in brightness between adjacent images. Those skilled in the art will understand that when the vehicle has more than one camera 140, the scale of the multiple processed ground images should be consistent.

In step 840, receiving the vehicle information, and writing the processed images to the corresponding locations of the image map based on the received vehicle information. The vehicle information may include the vehicle's position and heading angle. In one embodiment, since the map is initialized, the vehicle's position can be set at the center of the blank image map, and the vehicle's heading angle can be aligned with one of the two axes of the blank image map. In another embodiment, the vehicle's heading position stored before the shutdown of the moving image map processing device 100 can be read, without requiring the previous vehicle's heading angle to align with one of the two axes of the blank image map.

In step 850, setting the conditions for updating the image map. Various conditions for updating the image map have been mentioned earlier and will not be repeated here. After completing the initialization image map method 710, the update image map method 720 and the display image map method 730 can be executed in parallel.

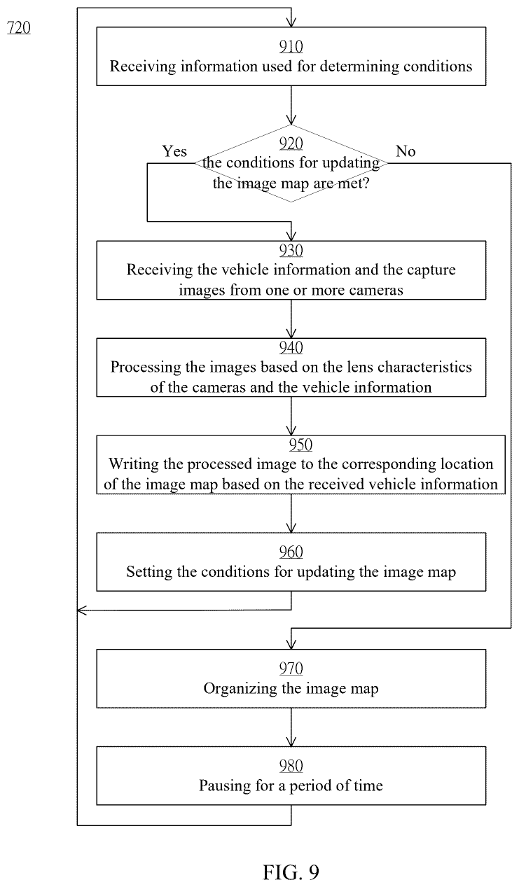

Referring to FIG. 9, there is shown a block diagram of the update image map method 720 according to one embodiment of the disclosure. The update image map method 720 can start at step 910.

In step 910, receiving information required for step 920.

In step 920, determining whether the conditions for updating the image map are met.

If the conditions are met, it will proceed to step 930. If the conditions for updating the image map are not met, the process may proceed to optional step 930, optional step 940, or directly return to step 910.

In step 930, receiving the vehicle information and the capture images from one or more cameras 140. In one embodiment, the captured images can be stored in parallel through Direct Memory Access (DMA).

In step 940, processing the aforementioned images based on the lens characteristics of the cameras and the vehicle information. For example, it may include steps such as ground projection, map coordinate transformation, brightness adjustment, and others.

In step 950, writing the processed image to the corresponding location of the image map based on the received vehicle information.

In step 960, setting the conditions for updating the image map. Then, the process can return to step 910.

In optional step 970, organizing the image map 930. Since the initialized image map cannot be infinitely large, when the conditions for updating the image map are not met, it is possible to delete image maps that are too far from the vehicle's position or the blank image maps can be increased. In one embodiment, step 930 can be performed in thread or process in another parallel execution, without affecting the map update.

In optional step 980, pausing for a period of time. As mentioned earlier, when the vehicle is stationary or moving very slowly, it is possible to pause for a period of time before determining whether the conditions for updating the image map are met. Then, the process returns to step 910.

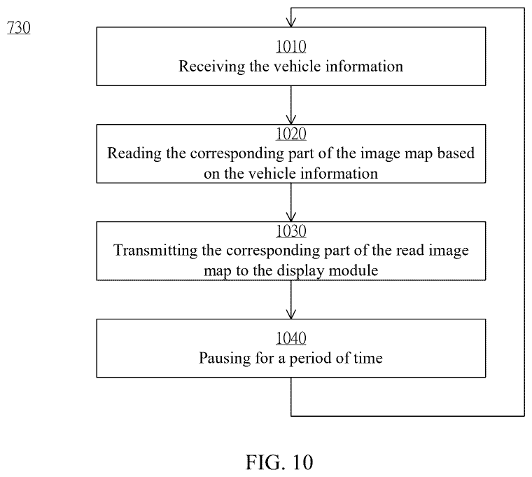

Referring to FIG. 10, there is a block diagram of the display image map method 730 according to one embodiment of the disclosure. The display image map method 730 can start at step 1010.

In step 1010, receiving the vehicle information.

In step 1020, reading the corresponding part of the image map based on the vehicle information.

In step 1030, transmitting the corresponding part of the read image map to the display module 170.

In optional step 1040, pausing for a period of time. Since the update rate of the display module 170 (such as 30 frames per second) may be lower than the execution time from step 1010 to step 1030, it is possible to pause for a period of time and then return to step 1010.

In one embodiment, the disclosure provides an update image map method applied to a vehicle, comprising: receiving a message used to determine whether conditions for updating an image map are met; determining whether the conditions for updating the image map are met according to the message; when it is determined that the conditions for updating the image map are met, further comprising: receiving a vehicle information and capturing images from one or more cameras; processing the images based on lens characteristics of the one or more cameras and the vehicle information; and writing the processed images to a corresponding location on the image map based on the received vehicle information.

Preferably, in order to determine the corresponding location of the image map, wherein the vehicle information includes a current position and a current heading angle of the vehicle.

Preferably, in order to obtain the vehicle information is obtained from one or any combination of the following: a vehicle information system; and a navigation and positioning system.

Preferably, in order to smooth the brightness of the images in the image map, wherein the step of processing the images further includes adjusting a brightness of the written images based on one or any combination of the following: according to existing images around the corresponding location on the image map; and according to adjacent received images.

Preferably, in order to satisfy the driver's situation awareness, wherein the conditions for updating the image map includes one or any combination of the following: a relative displacement of the vehicle exceeds a threshold; a relative heading angle of the vehicle exceeds another threshold; a current speed of the vehicle exceeds a speed threshold; a steering angle of a steering mechanism of the vehicle exceeds a steering angle threshold; and a time elapsed since the previous step of writing the processed images exceeds a time threshold.

Preferably, in order to provide the conditions for determining the next update image map, the update image map method further comprising: setting the conditions for updating the image map.

Preferably, in order to have enough time to organize the image map, wherein when it is determined that the conditions for updating the image map are not met, executing one or a combination of the following steps: organizing the image map; and pausing for a period of time.

Preferably, in order to display a portion of the image map that corresponds to the current location of the vehicle, the disclosure further provides a display image map method, comprising: executing the update image map method as previously described; reading a corresponding part of the image map based on the vehicle information; and transmitting the corresponding part of the read image map to a display module and displaying the corresponding part of the read image map on the display module.

Preferably, in order to initialize the image before updating the image map, the disclosure further provides an initialization image map method, comprising the following steps before executing the update image map method as previously described: creating a blank image map; executing the step of receiving the vehicle information; executing the step of processing the images; executing the step of writing the processed images to the corresponding location on the image map; and executing the update image map method.

In one embodiment, the disclosure further provides a moving image map processing device, comprising: at least one processor, used to execute a plurality of instructions to implement the update image map method as previously described; and a memory, used to store the image map.

In one embodiment, the disclosure further provides a moving image map processing device, comprising: at least one processor, used to execute a plurality of instructions to implement the display image map method as previously described; a memory, used to store the image map; and an input and output interface, used to transmit the corresponding part of the read image map to the display module.

In one embodiment, the disclosure further provides a moving image map processing system, comprising the moving image map processing device and the display module.

In one embodiment, the disclosure further provides a vehicle having moving image map processing capability, comprising: the moving image map processing system and the one or more cameras.

In one embodiment, the disclosure further provides a moving image map processing device, comprising: at least one processor, used to execute a plurality of instructions to implement the initialization image map method as previously described; and a memory, used to store the image map.

According to various embodiments, this disclosure provides an information system that can offer situational awareness of the area surrounding the vehicle while using fewer computational resources, thereby reducing costs and providing drivers with situational awareness at normal driving speeds.

1. An update image map method applied to a vehicle, comprising:
receiving a message used to determine whether conditions for updating an image map are met;
determining whether the conditions for updating the image map are met according to the message;
when it is determined that the conditions for updating the image map are met, further comprising:
receiving a vehicle information and capturing images from one or more cameras;
processing the images based on lens characteristics of the one or more cameras and the vehicle information; and
writing the processed images to a corresponding location on the image map based on the received vehicle information.

2. The update image map method applied to the vehicle according to claim 1, wherein the vehicle information includes a current position and a current heading angle of the vehicle.

3. The update image map method applied to the vehicle according to claim 1, wherein the vehicle information is obtained from one or any combination of the following:
a vehicle information system; and
a navigation and positioning system.

4. The update image map method applied to the vehicle according to claim 1, wherein the step of processing the images further includes adjusting a brightness of the written images based on one or any combination of the following:
according to existing images around the corresponding location on the image map; and
according to adjacent received images.

5. The update image map method applied to the vehicle according to claim 1, wherein the conditions for updating the image map includes one or any combination of the following:
a relative displacement of the vehicle exceeds a threshold;
a relative heading angle of the vehicle exceeds another threshold;
a current speed of the vehicle exceeds a speed threshold;
a steering angle of a steering mechanism of the vehicle exceeds a steering angle threshold; and
a time elapsed since the previous step of writing the processed images exceeds a time threshold.

6. The update image map method applied to the vehicle according to claim 1, further comprising:
setting the conditions for updating the image map.

7. The update image map method applied to the vehicle according to claim 1, wherein when it is determined that the conditions for updating the image map are not met, executing one or a combination of the following steps:
organizing the image map; and
pausing for a period of time.

8. A display image map method, comprising:
executing the update image map method of claim 1;
reading a corresponding part of the image map based on the vehicle information; and
transmitting the corresponding part of the read image map to a display module and displaying the corresponding part of the read image map on the display module.

9. An initialization image map method, comprising the following steps before executing the update image map method of claim 1:
creating a blank image map;
executing the step of receiving the vehicle information;
executing the step of processing the images;
executing the step of writing the processed images to the corresponding location on the image map; and
executing the update image map method.

10. A moving image map processing device, comprising:
at least one processor, used to execute a plurality of instructions to implement the update image map method of claim 1; and
a memory, used to store the image map.

11. A moving image map processing device, comprising:
at least one processor, used to execute a plurality of instructions to implement the display image map method of claim 8;
a memory, used to store the image map; and
an input and output interface, used to transmit the corresponding part of the read image map to the display module.

12. A moving image map processing system, comprising the moving image map processing device and the display module of claim 11.

13. A vehicle having moving image map processing capability, comprising: the moving image map processing system and the one or more cameras of claim 12.

14. A moving image map processing device, comprising:
at least one processor, used to execute a plurality of instructions to implement the initialization image map method of claim 9; and
a memory, used to store the image map.
